(19) United States
(12) Patent Application Publication
(10) Pub. No.: US 2025/0004391 A1
(43) Pub. Date: Jan. 2, 2025

(54) MANUFACTURING METHOD OF ELECTROSTATIC CHARGE IMAGE DEVELOPING TONER

(71) Applicant: FUJIFILM Business Innovation Corp., Tokyo (JP)

(72) Inventors: Keita YAMAMOTO, Kanagawa (JP); Takahiro YAMASHITA, Kanagawa (JP); Yuji ISSHIKI, Kanagawa (JP)

(73) Assignee: FUJIFILM Business Innovation Corp., Tokyo (JP)

(21) Appl. No.: 18/733,817

(22) Filed: Jun. 4, 2024

(30) Foreign Application Priority Data
Jun. 30, 2023 (JP) 2023-108945

(51) Int. Cl. G03G 9/08; G03G 9/087

(52) U.S. Cl. CPC G03G 9/0804; G03G 9/0823; G03G 9/08704; G03G 9/08755

(57) ABSTRACT

A manufacturing method of an electrostatic charge image developing toner includes a first aggregation step of aggregating polyester resin particles in a dispersion containing the polyester resin particles to form first aggregated particles, a second aggregation step of mixing the dispersion containing the first aggregated particles with a dispersion containing amorphous polyester resin particles, and while agitating the mixed dispersions, adhering the amorphous polyester resin particles on a surface of the first aggregated particles to form second aggregated particles, and a coalescence step of heating the dispersion containing the second aggregated particles for coalescing the second aggregated particles to form toner particles, in which the second aggregation step satisfies the following expression (1), expression (2), and expression (3),

$$35 \leq Tc \leq ( Tgs - 5 ) , \qquad expression ( 1 )$$

$$10 \leq Ts \leq Tc , \qquad expression ( 2 )$$

$$0.6 \leq ( P - P 0 ) \leq 3. , \qquad expression ( 3 )$$

where Tgs is a glass transition temperature (° C.) of an amorphous polyester resin contained in the amorphous polyester resin particles, Tc is a temperature (° C.) of the dispersion containing the first aggregated particles at a start of the mixing, Ts is a temperature (° C.) of the dispersion containing the amorphous polyester resin particles at the start of the mixing, P is an agitation power (kW/m³) per unit volume, and P0 is an idle agitation power (kW/m³) per unit volume.

### CROSS-REFERENCE TO RELATED APPLICATIONS

This application is based on and claims priority under 35 USC 119 from Japanese Patent Application No. 2023-108945 filed Jun. 30, 2023.

### BACKGROUND

### (i) Technical Field

The present disclosure relates to a manufacturing method of an electrostatic charge image developing toner.

### (ii) Related Art

JP2010-145611A discloses a toner manufacturing method including a first aggregation step of aggregating at least resin fine particles containing at least an amorphous polyester resin to manufacture a dispersion of a first toner particle precursor; a mixing step of mixing the dispersion of the first toner particle precursor and a dispersion of polyester resin fine particles having a carboxyl group to manufacture a dispersion of a second toner particle precursor, and a second aggregation step of aggregating at least the second toner particle precursor to form toner particles.

JP2012-128024A discloses a manufacturing method of an electrostatic latent image developing toner, the method including a step (1) of mixing resin particles (A) that contains a resin including a polyester resin (a) in an amount of 90% by weight or more, release agent particles that contains wax and a polyester resin (b) having a softening point of 75° C. to 105° C. with a weight ratio of 95/5 to 55/45, and an aggregating agent in an aqueous medium to obtain aggregated particles (1); a step (2) of mixing resin particles (B) that contains a polyester resin (c) serving as a shell with the aggregated particles (1) to obtain aggregated particles (2); and a step (3) of fusing particles constituting the aggregated particles (2) to obtain core/shell particles.

### SUMMARY

Aspects of non-limiting embodiments of the present disclosure relate to a manufacturing method of an electrostatic charge image developing toner, with which a target charge amount is easily achieved.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific methods for achieving the above-described object include the following aspects.

According to an aspect of the present disclosure, there is provided a manufacturing method of an electrostatic charge image developing toner, including: a first aggregation step of aggregating polyester resin particles in a dispersion containing the polyester resin particles to form first aggregated particles; a second aggregation step of mixing the dispersion containing the first aggregated particles with a dispersion containing amorphous polyester resin particles, and while agitating the mixed dispersions, adhering the amorphous polyester resin particles on a surface of the first aggregated particles to form second aggregated particles; and a coalescence step of heating the dispersion containing the second aggregated particles for coalescing the second aggregated particles to form toner particles, in which the second aggregation step satisfies the following expression (1), expression (2), and expression (3),

$$35 \leq Tc \leq ( Tgs - 5 ) , \qquad expression ( 1 )$$

$$10 \leq Ts \leq Tc , \qquad expression ( 2 )$$

$$0.6 \leq ( P - P 0 ) \leq 3. , \qquad expression ( 3 )$$

where Tgs is a glass transition temperature (° C.) of an amorphous polyester resin contained in the amorphous polyester resin particles, Tc is a temperature (° C.) of the dispersion containing the first aggregated particles at a start of the mixing, Ts is a temperature (° C.) of the dispersion containing the amorphous polyester resin particles at the start of the mixing, P is an agitation power (kW/m³) per unit volume, and P0 is an idle agitation power (kW/m³) per unit volume.

### BRIEF DESCRIPTION OF THE DRAWINGS

Exemplary embodiment(s) of the present invention will be described in detail based on the following figures, wherein:

FIG. 1 is a schematic configuration view showing an exemplary embodiment example of an agitated vessel used in a manufacturing method of an electrostatic charge image developing toner according to the present exemplary embodiment.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit value or lower limit value of a numerical range may be replaced with the upper limit value or lower limit value of another numerical range described in stages. Furthermore, in the present disclosure, the upper limit or lower limit of a numerical range may be replaced with values described in examples.

In the present disclosure, the term “step” includes not only an independent step but a step that is not clearly distinguished from other steps as long as the purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, “(meth)acrylic” is an expression including both acrylic and methacrylic, and “(meth)acrylate” is an expression including both acrylate and methacrylate.

In the present disclosure, a “toner” refers to an “electrostatic charge image developing toner”, a “developer” refers to an “electrostatic charge image developer”, and a “carrier” refers to an “electrostatic charge image developing carrier”.

In the present disclosure, a method of manufacturing toner particles by aggregating and coalescing material particles in a dispersion medium is referred to as an emulsion aggregation (EA) method.

### Manufacturing Method of Electrostatic Charge Image Developing Toner

The manufacturing method of a toner according to the present exemplary embodiment is a manufacturing method of a toner, including manufacturing toner particles by the EA method, and includes the following first aggregation step, second aggregation step, and coalescence step.

First aggregation step: step of aggregating polyester resin particles in a dispersion containing the polyester resin particles to form first aggregated particles

Second aggregation step: step of mixing the dispersion containing the first aggregated particles with a dispersion containing amorphous polyester resin particles, and while agitating the mixed dispersions, adhering the amorphous polyester resin particles on a surface of the first aggregated particles to form second aggregated particles

Coalescence step: step of heating the dispersion containing the second aggregated particles for coalescing the second aggregated particles to form toner particles

The first aggregation step is a step for forming a core in toner particles having a core/shell structure. The second aggregation step is a step for forming a shell in toner particles having a core/shell structure. By passing through the first aggregation step, the second aggregation step, and the coalescence step, toner particles having a core/shell structure can be manufactured.

In the manufacturing method of a toner according to the present exemplary embodiment, the second aggregation step satisfies the following expression (1), expression (2), and expression (3).

$$35 \leq Tc \leq ( Tgs - 5 ) \qquad Expression ( 1 )$$

$$10 \leq Ts \leq Tc \qquad Expression ( 2 )$$

$$0.6 \leq ( P - P 0 ) \leq 3. \qquad Expression ( 3 )$$

Tgs is a glass transition temperature (° C.) of an amorphous polyester resin contained in the amorphous polyester resin particles.

Tc is a temperature (° C.) of the dispersion containing the first aggregated particles at a start of the mixing.

Ts is a temperature (° C.) of the dispersion containing the amorphous polyester resin particles at the start of the mixing.

P is an agitation power (kW/m³) per unit volume.

P0 is an idle agitation power (kW/m³) per unit volume.

During the second aggregation step, a dispersion obtained by mixing the dispersion containing the first aggregated particles with the dispersion containing the amorphous polyester resin particles is agitated at an agitation power satisfying the expression (3). It is sufficient that the value of (P−P0) is within the range of the expression (3) during the second aggregation step, and the value of (P−P0) may be constant or may be changed.

The value of (P−P0) is controlled by the viscosity and amount of the dispersion, the shape and dimensions of the agitation unit, and the rotation speed of the agitation unit.

The value of P (kW/m³) is calculated by dividing a driving power (KW) of the agitation unit that is operated in the second aggregation step by a volume (m³) of the dispersion in the second aggregation step. The volume of the dispersion in the second aggregation step is gradually changed (in an initial stage of the second aggregation step, the volume is gradually increased by mixing the dispersion containing the first aggregated particles with the dispersion containing the amorphous polyester resin particles), and is a volume at each point in time during the second aggregation step. The driving power of the agitation unit is also a driving power at each point in time during the second aggregation step.

The value of P0 (kW/m³) is determined by (1) and (2) below.

(1) An approximate expression showing a relationship between the rotation speed (rpm) and the driving power (kW) of the agitation unit used in the second aggregation step is created; the approximate expression is created based on values obtained by rotating the agitation unit in a state in which the dispersion is absent (referred to as “idling rotation”) and changing the rotation speed in four stages to measure the driving power at four points; among the four points, one point is to measure a driving power at the lowest possible rotation speed, and one point is to measure a driving power at the rotation speed of the agitation unit at the start of the mixing in the second aggregation step; in a case where the agitation unit is not recommended for idling rotation, the driving power is four-point-measured at the lowest four-stage rotation speed.

(2) The driving power (KW) is calculated by substituting the rotation speed (rpm) of the agitation unit that is operated in the second aggregation step into the approximate expression, and the calculated driving power is divided by the volume (m³) of the dispersion in the second aggregation step to calculate the value of P0 (kW/m³); the volume of the dispersion in the second aggregation step is gradually changed (in an initial stage of the second aggregation step, the volume is gradually increased by mixing the dispersion containing the first aggregated particles with the dispersion containing the amorphous polyester resin particles.), and is a volume at each point in time during the second aggregation step; the driving power of the agitation unit is also a driving power at each point in time during the second aggregation step.

According to the manufacturing method of a toner according to the present exemplary embodiment, in the second aggregation step, the particle size of the toner particles is controlled to a target value by satisfying the expression (1), expression (2), and expression (3), and as a result, a toner in which a target charge amount in a developer is easily achieved is manufactured. The target charge amount of the developer is, in a case of negative charging, for example, −90 μC/g or more and −35 μC/g or less.

In the second aggregation step, in a case where the amorphous polyester resin particles adhere to the surface of the first aggregated particles, and the second aggregated particles grow, the particle size of the second aggregated particles varies depending on a balance between an aggregation force between the particles and a shear force due to the agitation. It is presumed that, in a case where the second aggregation step satisfies the expression (1), expression (2), and expression (3), the second aggregated particles grow stably, and the particle size of the toner particles easily grows within a target range.

In a case where Tc is lower than 35° C., since the aggregation force between the particles is too low and the shear force due to the agitation is excessive, the adhesion of the amorphous polyester resin particles is insufficient, the particle size growth is small, and the proportion of fine particles is likely to be large. From the viewpoint of suppressing the event, Tc is 35° C. or higher, and for example, preferably 38° C. or higher and more preferably 40° C. or higher.

In a case where Tc exceeds (Tgs−5), since the aggregation force between the particles is excessively increased and the shear force due to the agitation is insufficient, the adhesion of the amorphous polyester resin particles is excessive, the particle size growth is large, the unevenness of the aggregation force occurs, and the proportion of coarse particles is likely to be large. From the viewpoint of suppressing the event, Tc is (Tgs−5) or lower, and for example, preferably (Tgs−7) or lower and more preferably (Tgs−10) or lower.

From the viewpoint of improving heat storage stability of the toner, Tgs is, for example, preferably 50° C. or higher, more preferably 52° C. or higher, and still more preferably 54° C. or higher.

From the viewpoint of improving low-temperature fixability of the toner, Tgs is, for example, preferably 70° C. or lower, more preferably 68° C. or lower, and still more preferably 65° C. or lower.

In a case where Ts is lower than 10° C., since the temperature of the dispersion containing the first aggregated particles is locally lowered and the temperature of the entire system is also lowered, the aggregation force between the particles is lowered, the particle size growth is small, and the proportion of fine particles is likely to large. From the viewpoint of suppressing the event, Ts is 10° C. or higher, and for example, preferably 12° C. or higher and more preferably 15° C. or higher.

In a case where Ts exceeds Tc, since the temperature of the dispersion containing the first aggregated particles locally increases and the temperature of the entire system also increases, the aggregation force between the particles is excessively increased, the particle size growth is increased, the unevenness of the aggregation force occurs, and the proportion of coarse particles is likely to increase. From the viewpoint of suppressing the event, Ts is Tc or lower, and for example, preferably (Tc−10) or lower and more preferably (Tc−20) or lower.

In a case where (P−P0) is less than 0.6, the shear force due to the agitation is insufficient, so that it is difficult to maintain the particle size growth constant against a disturbance such as a property of the resin or a temperature. From the viewpoint of suppressing the event, (P−P0) is 0.6 or more, and for example, preferably 0.8 or more and more preferably 1.0 or more.

In a case where (P−P0) is more than 3.0, the shear force due to the agitation is excessive, so that the proportion of fine particles is increased, and it is difficult to maintain the particle size growth constant. From the viewpoint of suppressing the event, (P−P0) is 3.0 or less, and for example, preferably 2.0 or less and more preferably 1.5 or less.

In the manufacturing method of a toner according to the present exemplary embodiment, for example, it is preferable that the second aggregation step further satisfies the following expression (4) and expression (5).

$$10 \leq Wc \leq 20 \qquad Expression ( 4 )$$

$$5 \leq ( Ws - Wc ) \leq 20 \qquad Expression ( 5 )$$

Wc is a concentration of solid contents (% by mass) of the dispersion containing the first aggregated particles at the start of the mixing.

Ws is a concentration of solid contents (% by mass) of the dispersion containing the amorphous polyester resin particles at the start of the mixing.

From the viewpoint of improving particle size controllability and reducing the proportion of fine particles, Wc is, for example, preferably 10% by mass or more, more preferably 11% by mass or more, and still more preferably 12% by mass or more.

From the viewpoint of suppressing mixing unevenness, Wc is, for example, preferably 20% by mass or less, more preferably 18% by mass or less, and still more preferably 16% by mass or less.

From the viewpoint of improving the aggregation force between the particles and improving adhesive property of the fine particles, for example, (Ws−Wc) is preferably 5% by mass or more, more preferably 8% by mass or more, and still more preferably 10% by mass or more.

From the viewpoint of improving the aggregation force between the particles and uniformizing the particle size growth of the aggregated particles, (Ws−Wc) is, for example, preferably 20% by mass or less, more preferably 19% by mass or less, and still more preferably 18% by mass or less.

From the viewpoint of improving the adhesion force during the shell formation, Ws is, for example, preferably 15% by mass or more, more preferably 20% by mass or more, and still more preferably 25% by mass or more.

From the viewpoint of improving miscibility (reducing the viscosity) of the dispersion for shell formation, Ws is, for example, preferably 45% by mass or less, more preferably 40% by mass or less, and still more preferably 35% by mass or less.

In the first aggregation step, the second aggregation step, and the coalescence step, for example, it is preferable that the first aggregation step, the second aggregation step, and the coalescence step are carried out in an agitated vessel provided with an agitation unit and a heating and cooling unit. The agitation unit is, for example, preferably an agitation unit including a rotation shift and an agitation blade. The heating and cooling unit is, for example, a unit that applies and/or absorbs heat from a wall surface of the agitated vessel.

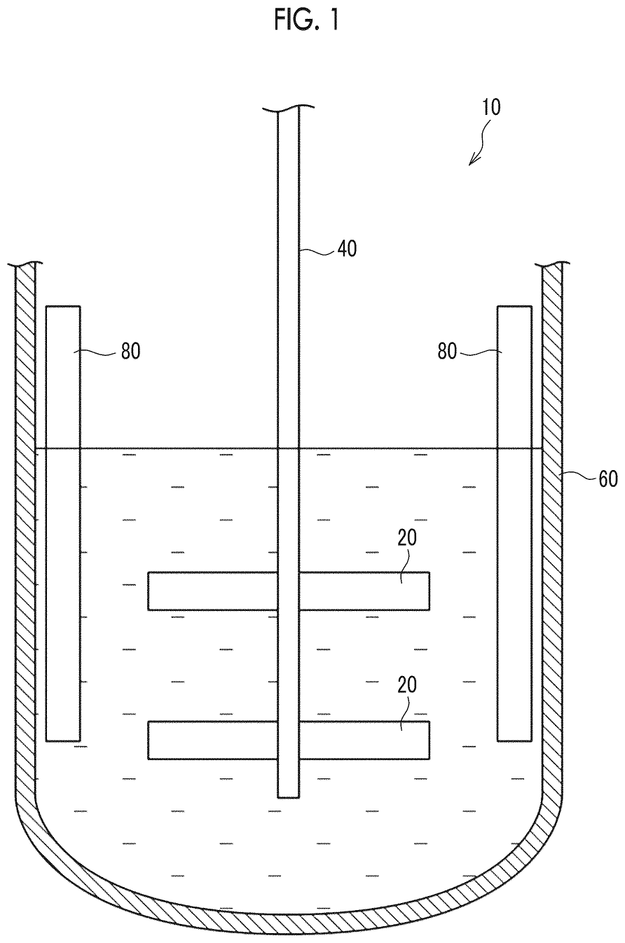

FIG. 1 is a schematic configuration view showing an exemplary embodiment example of the agitated vessel.

An agitated vessel 10 shown in FIG. 1 includes paddle blades 20 that are an example of the agitation unit, and a jacket 60 that is an example of the heating and cooling unit.

The paddle blades 20 are provided in two stages on a rotation shaft 40. The rotation shaft 40 and the paddle blades 20 are rotated by a driving device (not shown) to agitate the dispersion contained in the agitated vessel 10.

The jacket 60 has a flow path through which steam, water, or oil flows, and heats or cools the dispersion contained in the agitated vessel 10 from a wall surface of the agitated vessel 10.

The agitated vessel 10 may further include baffles 80. The baffles 80 are plate-shaped or cylinder-shaped, and are provided on an inner side surface of the agitated vessel 10 in two, three, or four at equal intervals.

Hereinafter, the steps and materials of the manufacturing method of a toner according to the present exemplary embodiment will be described in detail.

### First Aggregation Step

The first aggregation step is a step of aggregating at least polyester resin particles in a dispersion containing at least the polyester resin particles to form first aggregated particles.

Examples of the polyester resin particles include amorphous polyester resin particles and crystalline polyester resin particles. As the polyester resin particles, only amorphous polyester resin particles may be used, only crystalline polyester resin particles may be used, or amorphous polyester resin particles and crystalline polyester resin particles may be used in combination.

Examples of a form of the dispersion to be subjected to the first aggregation step include a dispersion containing amorphous polyester resin particles and crystalline polyester resin particles, in which the total amount of the amorphous polyester resin particles and the crystalline polyester resin particles is 45% by mass or more of the total solid content of the dispersion.

In a case where the total amount of both polyester resin particles is 45% by mass or more of the total solid content of the dispersion, the amorphous polyester resin particles are likely to adhere to the surface of the first aggregated particles in the second aggregation step. From the viewpoint, the total amount of both polyester resin particles is, for example, more preferably 60% by mass or more, and still more preferably 75% by mass or more of the total solid content of the dispersion.

The total amount of both polyester resin particles may be 100% by mass, 95% by mass or less, or 85% by mass or less of the total solid content of the dispersion.

In a case where the dispersion to be subjected to the first aggregation step contains the amorphous polyester resin particles and the crystalline polyester resin particles, a content ratio of both polyester resin particles (amorphous polyester resin particles: crystalline polyester resin particles; mass ratio) is, for example, preferably 98:2 to 70:30, more preferably 95:5 to 75:25, and still more preferably 90:10 to 80:20.

The dispersion to be subjected to the first aggregation step may contain at least one of vinyl-based resin particles, release agent particles, or colorant particles. Therefore, the first aggregation step may be a step of aggregating at least one of the vinyl-based resin particles, the release agent particles, or the colorant particles together with the polyester resin particles.

The dispersion to be subjected to the first aggregation step is produced by, for example, preparing a dispersion of amorphous polyester resin particles, containing amorphous polyester resin particles, a dispersion of crystalline polyester resin particles, containing crystalline polyester resin particles, a dispersion of vinyl-based resin particles, containing vinyl-based resin particles, a dispersion of release agent particles, containing release agent particles, and a dispersion of colorant particles, containing colorant particles, and mixing these particle dispersions. The order of mixing these particle dispersions is not limited.

Hereinafter, the amorphous polyester resin particle dispersion, the crystalline polyester resin particle dispersion, the vinyl-based resin particle dispersion, the release agent particle dispersion, and the colorant particle dispersion will be collectively referred to as “particle dispersion” in common.

An example of an exemplary embodiment of the particle dispersion is a dispersion obtained by dispersing a material in a dispersion medium in a particulate form, using a surfactant.

As the dispersion medium of the particle dispersion, for example, an aqueous medium is preferable. Examples of the aqueous medium include water and alcohol. As the water, for example, water having a reduced ion content, such as distilled water and deionized water, is preferable. One kind of aqueous medium may be used alone, or two or more kinds of aqueous media may be used in combination.

The surfactant that disperses the material in the dispersion medium may be any of an anionic surfactant, a cationic surfactant, or a nonionic surfactant. Examples thereof include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. One kind of surfactant may be used alone, or two or more kinds of surfactants may be used in combination. The nonionic surfactant may be used in combination with the anionic surfactant or the cationic surfactant.

Examples of the method of dispersing the material in the dispersion medium in a particulate form include known dispersion methods such as a rotating shear type homogenizer, a ball mill having a medium, a sand mill, and a dyno mill.

Examples of the method of dispersing the resin in the dispersion medium in a particulate form include a phase-transfer emulsification method. An example of the phase-transfer emulsification method is a method of dissolving the resin in a hydrophobic organic solvent in which the resin is soluble, adding a base to an organic continuous phase (O phase) for causing neutralization, and then adding the aqueous medium (W phase) to perform a phase transition from W/O to O/W, thereby dispersing the resin in the aqueous medium in a particulate form.

A volume-average particle size of the particles dispersed in the particle dispersion is, for example, preferably 30 nm or more and 300 nm or less, more preferably 50 nm or more and 250 nm or less, and still more preferably 80 nm or more and 200 nm or less.

The volume-average particle size of the particles in the particle dispersion refers to a particle size at which 50% of the particles are accumulated from a small size side in a particle size distribution measured with a laser diffraction-type particle size distribution analyzer (for example, LA-700 manufactured by HORIBA, Ltd.).

A content of the particles contained in each particle dispersion is, for example, preferably 5% by mass or more and 50% by mass or less, more preferably 10% by mass or more and 40% by mass or less, and still more preferably 15% by mass or more and 30% by mass or less.

Hereinafter, materials constituting each of the particles in the amorphous polyester resin particle dispersion, the crystalline polyester resin particle dispersion, the vinyl-based resin particle dispersion, the release agent particle dispersion, and the colorant particle dispersion will be described.

### Amorphous Polyester Resin

As the amorphous polyester resin, a commercially available product may be used, or a synthetic resin may be used.

Examples of the amorphous polyester resin include a polycondensate of a polyvalent carboxylic acid and a polyhydric alcohol.

Examples of the polyvalent carboxylic acid that is a polymerization component of the amorphous polyester resin include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among the above, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol that is a polymerization component of the amorphous polyester resin include aliphatic diols (for example, ethylene glycol, diethylene glycol, triethylene glycol, propylene glycol, neopentyl glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-cicosanedecanediol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the above, for example, aliphatic diols are preferable as the polyhydric alcohol.

As the polyhydric alcohol that is a polymerization component of the amorphous polyester resin, a polyhydric alcohol having a valency of 3 or more and a crosslinked structure or a branched structure may be used in combination with a diol. Examples of the polyhydric alcohol having a valency of 3 or more include glycerin, trimethylolpropane, and pentaerythritol.

One kind of polyhydric alcohol may be used alone, or two or more kinds of polyhydric alcohols may be used in combination.

A glass transition temperature (Tg) of the amorphous polyester resin is, for example, preferably 50° C. or higher and 70° C. or lower, more preferably 52° C. or higher and 68° C. or lower, and still more preferably 54° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

A weight-average molecular weight (Mw) of the amorphous polyester resin is, for example, preferably 5,000 or more and 1,000,000 or less, and more preferably 7,000 or more and 500,000 or less.

A number-average molecular weight (Mn) of the amorphous polyester resin is, for example, preferably 2,000 or more and 100,000 or less.

A molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC·HLC-8120GPC manufactured by Tosoh Corporation as a measurement device, TSKgel Super HM-M (15 cm) manufactured by Tosoh Corporation as a column, and THF as a solvent. The weight-average molecular weight and the number-average molecular weight are calculated using a molecular weight calibration curve plotted using a monodisperse polystyrene standard sample from the measurement results.

The amorphous polyester resin is obtained by a known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the copolymerization reaction, for example, the monomer with poor compatibility may be condensed in advance with an acid or an alcohol that is to be polycondensed with the monomer, and then polycondensed with the major component.

### Crystalline Polyester Resin

As the crystalline polyester resin, a commercially available product may be used, or a synthetic resin may be used.

Examples of the crystalline polyester resin include a polycondensate of polyvalent carboxylic acid and polyhydric alcohol. Since the crystalline polyester resin easily forms a crystal structure, the crystalline polyester resin is, for example, preferably a polycondensate formed of a linear aliphatic polymerizable monomer than a polycondensate formed of a polymerizable monomer having an aromatic ring.

Examples of the polyvalent carboxylic acid that is a polymerization component of the crystalline polyester resin include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol that is a polymerization component of the crystalline polyester resin include an aliphatic diol (for example, a linear aliphatic diol having 7 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol.

As the polyhydric alcohol that is a polymerization component of the crystalline polyester resin, an alcohol having a valency of 3 or more and having a crosslinked structure or a branched structure may be used in combination with a diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

A melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

A weight-average molecular weight (Mw) of the crystalline polyester resin is, for example, preferably 6,000 or more and 35,000 or less.

The crystalline polyester resin can be obtained by a known manufacturing method, for example, same as the amorphous polyester resin.

### Vinyl-Based Resin

Examples of the vinyl-based resin include polyolefin, a styrene-based resin, a (meth)acrylic resin, and a styrene (meth)acrylic resin. As the vinyl-based resin, for example, a styrene (meth)acrylic resin is preferable. Examples of the styrene (meth)acrylic resin include a resin obtained by polymerizing the following styrene-based monomer and (meth)acrylic acid-based monomer.

Examples of the styrene-based monomer include styrene, α-methylstyrene, vinylnaphthalene; alkyl-substituted styrene such as 2-methylstyrene, 3-methylstyrene, 4-methylstyrene, 2-ethylstyrene, 3-ethylstyrene, and 4-ethylstyrene; halogen-substituted styrene such as 2-chlorostyrene, 3-chlorostyrene, and 4-chlorostyrene; and fluorine-substituted styrene such as 4-fluorostyrene and 2,5-difluorostyrene. As the styrene-based monomer, for example, styrene or α-methylstyrene is preferable. The styrene-based monomer may be used alone or in combination of two or more kinds thereof.

Examples of the (meth)acrylic acid-based monomer include (meth)acrylic acid, methyl (meth)acrylate, ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminocthyl (meth)acrylate, diethylaminoethyl (meth)acrylate, methoxyethyl (meth)acrylate, 2-hydroxyethyl (meth)acrylate, 2-carboxyethyl (meth)acrylate, 2-carboxypropyl (meth)acrylate, 3-carboxypropyl (meth)acrylate, 4-carboxybutyl (meth)acrylate, (meth)acrylonitrile, and (meth)acrylamide. The (meth)acrylic acid-based monomer may be used alone or in combination of two or more kinds thereof.

As the (meth)acrylic acid-based monomer, for example, a lower alkyl ester (meth)acrylate is preferable. The “lower alkyl” in the lower alkyl ester (meth)acrylate means having 1 or more and 5 or less carbon atoms, and the “lower alkyl” has, for example, preferably 2 or more and 4 or less carbon atoms, and more preferably 3 or 4 carbon atoms.

Examples of the lower alkyl ester (meth)acrylate include methyl (meth)acrylate, ethyl (meth)acrylate, n-propyl (meth)acrylate, n-butyl (meth)acrylate, n-pentyl (meth)acrylate, isopropyl (meth)acrylate, isobutyl (meth)acrylate, t-butyl (meth)acrylate, isopentyl (meth)acrylate, and neopentyl (meth)acrylate. Among these, for example, ethyl (meth)acrylate, n-propyl (meth)acrylate, or n-butyl (meth)acrylate is preferable, and n-butyl (meth)acrylate is particularly preferable.

A polymerization ratio of the styrene-based monomer and the (meth)acrylic acid-based monomer (based on mass, styrene-based monomer: (meth)acrylic acid-based monomer) is, for example, preferably 30:70 to 70:30, more preferably 40:60 to 60:40, and still more preferably 45:55 to 55:45.

A solubility parameter of the vinyl-based resin is, for example, preferably 8.0 (cal/cm³)^{0.5} or more and 11.5 (cal/cm³)^{0.5} or less, more preferably 8.5 (cal/cm³)^{0.5} or more and 10.5 (cal/cm³)^{0.5} or less, and still more preferably 9.0 (cal/cm³)^{0.5} or more and 10.0 (cal/cm³)^{0.5} or less.

The solubility parameter of the vinyl-based resin is a value estimated by the Fedors method.

### Release Agent

Examples of the release agent include hydrocarbon-based wax; natural wax such as carnauba wax, rice wax, and candelilla wax; synthetic or mineral·petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature of the release agent is determined from a DSC curve obtained by differential scanning calorimetry (DSC) by “peak melting temperature” described in the method for determining the melting temperature in JIS K7121-1987, “Testing methods for transition temperatures of plastics”.

### Colorant

Examples of the colorant include pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye; and inorganic pigments such as a titanium compound and silica.

One kind of colorant may be used alone, or two or more kinds of colorants may be used in combination.

The colorant is not limited to a substance having absorption in the visible light region. The colorant may be, for example, a substance having absorption in the near-infrared region, or may be a fluorescent colorant.

Examples of the colorant having absorption in the near-infrared region include an aminium salt-based compound, a naphthalocyanine-based compound, a squarylium-based compound, and a croconium-based compound.

Examples of the fluorescent colorant include the fluorescent colorants described in paragraph 0027 of JP2021-127431A.

The colorant may be a luminous colorant. Examples of the luminous colorant include metal powder such as aluminum, brass, bronze, nickel, stainless steel, and zinc; mica coated with titanium oxide or yellow iron oxide; a coated flaky inorganic crystal substrate such as barium sulfate, layered silicate, and silicate of layered aluminum; and monocrystal plate-shaped titanium oxide, basic carbonate, bismuth oxychloride, natural guanine, flaky glass powder, metal-deposited flaky glass powder.

One kind of colorant may be used alone, or two or more kinds of colorants may be used in combination.

As the colorant, a colorant having undergone a surface treatment as necessary may be used, or a dispersant may be used in combination with the colorant.

In the present exemplary embodiment, the toner particles may or may not contain a colorant. The toner in the present exemplary embodiment may be a toner that does not contain a colorant in the toner particles, so-called transparent toner.

In the colorant particle dispersion, for example, it is preferable that a zeta potential measured by adjusting the concentration of solid contents, the hydrogen ion concentration, and the temperature to 10% by mass, pH 6, and 25° C. is −40 mV or more and −15 mV or less.

In a case where the above-described zeta potential is −40 mV or more, appropriate aggregativity is likely to be exhibited, and the dispersion containing the first aggregated particles and the dispersion containing the amorphous polyester resin particles are likely to be uniformly adhered to each other in a case of being mixed with each other. From the viewpoint, the above-described zeta potential is, for example, more preferably-35 mV or more and still more preferably-30 mV or more.

In a case where the above-described zeta potential is −15 mV or less, excessive aggregation is less likely to be occur, and the dispersion containing the first aggregated particles and the dispersion containing the amorphous polyester resin particles are likely to be uniformly adhered to each other in a case of being mixed with each other. From the viewpoint, the above-described zeta potential is, for example, more preferably-20 mV or less and still more preferably −25 mV or less.

The zeta potential of the colorant particle dispersion can be controlled by the type of the colorant, and the type and the amount of the surfactant.

The zeta potential of the colorant particle dispersion is measured by an electrophoresis method (also referred to as Laser Doppler method). The measurement device is, for example, a zeta potential measurement system ELSZ-2000Z or ELSZ-2000ZS of Otsuka Electronics Co., Ltd. A part of the colorant particle dispersion is taken, diluted with deionized water to have a concentration of solid contents of 10% by mass, and the pH is adjusted to 6 using a 0.1 mol/L nitric acid or a 0.1 mol/L sodium hydroxide aqueous solution, thereby preparing a measurement sample. A liquid temperature of the measurement sample during the measurement is set to 25° C.

Hereinafter, the dispersion obtained by mixing a plurality of kinds of particle dispersions is referred to as “mixed dispersion”. The polyester resin and the vinyl-based resin are collectively referred to as “binder resin”, and the polyester resin particles and the vinyl-based resin particles are collectively referred to as “binder resin particles”.

A mass ratio of the particles contained in the mixed dispersion is, for example, preferably in the following range.

In a case where the mixed dispersion contains the release agent particles, a mass ratio of the binder resin particles and the release agent particles as binder resin particles: release agent particles is, for example, preferably 100:1 to 100:40, more preferably 100:2 to 100:30, and still more preferably 100:5 to 100:20.

In a case where the mixed dispersion contains the colorant particles, a mass ratio of the binder resin particles and the colorant particles as binder resin particles: colorant particles is, for example, preferably 100:1 to 100:100, more preferably 100:2 to 100:40, and still more preferably 100:5 to 100:20.

For example, it is preferable to adjust a pH of the mixed dispersion to a range of 3 or more and 4 or less after the mixing of the plurality of kinds of particle dispersions. Examples of a method of adjusting the pH of the mixed dispersion include adding an acidic aqueous solution such as a nitric acid aqueous solution, a hydrochloric acid aqueous solution, and a sulfuric acid aqueous solution.

The first aggregation step includes, for example, adding an aggregating agent to the mixed dispersion while agitating the mixed dispersion, and heating the mixed dispersion while agitating the mixed dispersion liquid after adding the aggregating agent to the mixed dispersion to raise a temperature of the mixed dispersion.

Examples of the aggregating agent include a surfactant having polarity opposite to the polarity of the surfactant contained in the mixed dispersion, an inorganic metal salt, and a metal complex having a valency of 2 or more. One kind of aggregating agent may be used alone, or two or more kinds of aggregating agents may be used in combination.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the aggregating agent, for example, a metal salt compound having a valency of 2 or more is preferable, a trivalent metal salt compound is more preferable, and a trivalent inorganic aluminum salt compound is still more preferable. Examples of the trivalent inorganic aluminum salt compound include aluminum chloride, aluminum sulfate, polyaluminum chloride, and polyaluminum hydroxide.

An amount of the aggregating agent added is not limited. In a case where the trivalent metal salt compound is used as the aggregating agent, an amount of the trivalent metal salt compound added is, for example, preferably 0.01 parts by mass or more and 10 parts by mass or less, more preferably 0.05 parts by mass or more and 5 parts by mass or less, and still more preferably 0.1 parts by mass or more and 3 parts by mass or less with respect to 100 parts by mass of the binder resin.

A reaching temperature of the mixed dispersion in a case of heating the mixed dispersion is, for example, preferably a temperature based on the glass transition temperature (Tg) of the binder resin particles, for example, (Tg-30)° C. or higher and (Tg° C.) or lower with regard to the binder resin particles.

In a case where the mixed dispersion contains a plurality of kinds of binder resin particles having different Tg's, the lowest temperature among the Tg's is defined as the Tg in the aggregation step.

### Second Aggregation Step

The second aggregation step is a step of mixing the dispersion containing the first aggregated particles with a dispersion containing at least amorphous polyester resin particles, and while agitating the mixed dispersions, adhering at least the amorphous polyester resin particles on a surface of the first aggregated particles to form second aggregated particles.

Hereinafter, the dispersion containing at least the amorphous polyester resin particles, that is used in the second aggregation step, is referred to as “dispersion for shell formation”.

A temperature (° C.) of the dispersion containing the first aggregated particles at the start of the mixing with the dispersion for shell formation is the Tc according to the expression (1), and a concentration of solid contents (% by mass) of the dispersion containing the first aggregated particles is the Wc according to the expression (4).

A temperature (° C.) of the dispersion for shell formation at the start of the mixing with the dispersion containing the first aggregated particles is the Ts according to the expression (2), and a concentration of solid contents (% by mass) of the dispersion for shell formation is the Ws according to the expression (5).

In a case where the dispersion contains a surfactant, the surfactant is also included in the solid content of the dispersion.

At the start of the second aggregation step, the temperature of the dispersion containing the first aggregated particles and the temperature of the dispersion for shell formation are adjusted so that the expression (1) and expression (2) are satisfied.

For example, it is preferable that, at the start of the second aggregation step, the concentration of solid contents of the dispersion containing the first aggregated particles and the concentration of solid contents of the dispersion for shell formation are adjusted so as to satisfy the expression (4) and expression (5).

Examples of one exemplary embodiment of the dispersion for shell formation include a dispersion containing amorphous polyester resin particles and release agent particles. In a case where the dispersion is subjected to the second aggregation step, a shell containing the amorphous polyester resin and the release agent is formed.

In a case where the dispersion containing amorphous polyester resin particles and release agent particles is used as the dispersion for shell formation, a temperature of the dispersion is the Ts according to the expression (2), and a concentration of solid contents of the dispersion is the Ws according to the expression (5).

The dispersion for shell formation may be the amorphous polyester resin particle dispersion, or may be a dispersion obtained by mixing the amorphous polyester resin particle dispersion with a dispersion of release agent particles in advance.

The form, material, and production method of the amorphous polyester resin particle dispersion and the release agent particle dispersion are the same as the form, material, and production method in the first aggregation step. The concentration of solid contents and the temperature of the dispersion of the amorphous polyester resin particles and the dispersion of the release agent particles, that are used in the first aggregation step, may be adjusted and then supplied to the second aggregation step.

The Tgs according to the expression (1), that is, the glass transition temperature of the amorphous polyester resin constituting the amorphous polyester resin particles contained in the dispersion for shell formation is, for example, preferably 50° C. or higher, more preferably 52° C. or higher, and still more preferably 54° C. or higher.

The Tgs according to the expression (1), that is, the glass transition temperature of the amorphous polyester resin constituting the amorphous polyester resin particles contained in the dispersion for shell formation is, for example, preferably 70° C. or lower, more preferably 68° C. or lower, and still more preferably 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

The amorphous polyester resin constituting the amorphous polyester resin particles contained in the dispersion for shell formation has an acid value of, for example, preferably 8 mgKOH/g or more and 16 mgKOH/g or less.

In a case where the acid value of the amorphous polyester resin is 8 mgKOH/g or more, excessive aggregation is less likely to be occur, and the dispersion containing the first aggregated particles and the dispersion containing the amorphous polyester resin particles are likely to be uniformly adhered to each other in a case of being mixed with each other. From the viewpoint, the acid value of the amorphous polyester resin is, for example, more preferably 8.5 mgKOH/g or more and still more preferably 9 mgKOH/g or more.

In a case where the acid value of the amorphous polyester resin is 16 mgKOH/g or less, appropriate aggregativity is likely to be exhibited, and the dispersion containing the first aggregated particles and the dispersion containing the amorphous polyester resin particles are likely to be uniformly adhered to each other in a case of being mixed with each other. From the viewpoint, the acid value of the amorphous polyester resin is, for example, more preferably 15 mgKOH/g or less and still more preferably 14 mgKOH/g or less.

The acid value of the amorphous polyester resin is determined by a neutralization titration method specified in JIS K 0070-1992.

A solubility parameter of the amorphous polyester resin constituting the amorphous polyester resin particles contained in the dispersion for shell formation is, for example, preferably 8.5 (cal/cm³)^{0.5} or more and 11.5 (cal/cm³)^{0.5} or less, more preferably 9.0 (cal/cm³)^{0.5} or more and 10.5 (cal/cm³)^{0.5} or less, and still more preferably 9.0 (cal/cm³)^{0.5} or more and 10.0 (cal/cm³)^{0.5} or less.

The solubility parameter of the amorphous polyester resin is a value estimated by the Fedors method.

In a case where the dispersion in the first aggregation step is a dispersion containing vinyl-based resin particles, for example, it is preferable that a difference between the solubility parameter of the vinyl-based resin contained in the vinyl-based resin particles and the solubility parameter of the amorphous polyester resin contained in the amorphous polyester resin particles of the second aggregation step is 1.0 (cal/cm³)^{0.5} or less. The solubility parameter of the vinyl-based resin and the solubility parameter of the amorphous polyester resin are values estimated by the Fedors method.

In a case where the above-described difference is 1.0 (cal/cm³)^{0.5} or less, the amorphous polyester resin particles are likely to adhere to the surface of the first aggregated particles containing the vinyl-based resin particles. From the viewpoint, the above-described difference is, for example, more preferably 0.8 (cal/cm³)^{0.5} or less, still more preferably 0.5 (cal/cm³)^{0.5} or less, and most preferably 0 (cal/cm³)^{0.5}.

The second aggregation step is carried out, for example, by adding the dispersion for shell formation to the dispersion containing the first aggregated particles while agitating the dispersion, and then heating the dispersion while agitating the dispersion. The agitating is performed with the agitation power satisfying the expression (3). A reaching temperature of the dispersion by the heating is preferably, for example, (Tgs−20° C.) or higher and (Tgs−10° C.) or lower with respect to the glass transition temperature (Tgs) of the amorphous polyester resin serving as the shell.

After the second aggregated particles have grown to a predetermined size, in order to stop the growth of the second aggregated particles before the heating in the coalescence step, a chelating agent for the aggregating agent used in the first aggregation step may be added to the dispersion containing the second aggregated particles.

Examples of the chelating agent include oxycarboxylic acids such as tartaric acid, citric acid, and gluconic acid; and aminocarboxylic acids such as iminodiacetic acid (IDA), nitrilotriacetic acid (NTA), and ethylenediaminetetraacetic acid (EDTA).

An amount of the chelating agent added with respect to 100 parts by mass of the binder resin particles is, for example, preferably 0.01 parts by mass or more and 5.0 parts by mass or less, and more preferably 0.1 parts by mass or more and less than 3.0 parts by mass.

After the second aggregated particles have grown to a predetermined size, in order to stop the growth of the second aggregated particles before the heating in the coalescence step, a pH of the dispersion containing the second aggregated particles may be increased.

Examples of a method of increasing the pH of the dispersion containing the second aggregated particles include addition of at least one selected from the group consisting of an aqueous solution of an alkali metal hydroxide and an aqueous solution of an alkaline earth metal hydroxide.

A reaching pH of the dispersion containing the second aggregated particles is preferably, for example, 8 or more and 10 or less.

### Coalescence Step

The coalescence step is a step of heating the dispersion containing the second aggregated particles for coalescing the second aggregated particles to form toner particles.

A reaching temperature of the dispersion containing the second aggregated particles is, for example, preferably equal to or higher than the glass transition temperature (Tg) of the amorphous polyester resin particles, and specifically, a temperature higher than Tg of the amorphous polyester resin particles by 10° C. to 30° C. is preferable, for example.

In a case where a plurality of kinds of amorphous polyester resin particles having different Tg are used through the first aggregation step and the second aggregation step, a highest temperature among the Tg's is defined as the glass transition temperature in the coalescence step.

After the coalescence step ends, the toner particles in the dispersion are subjected to known washing step, solid-liquid separation step, and drying step, thereby obtaining dry toner particles. As the washing step, from the viewpoint of charging properties, for example, displacement washing may be thoroughly performed using deionized water. As the solid-liquid separation step, from the viewpoint of productivity, for example, suction filtration, pressure filtration, or the like may be performed. As the drying step, from the viewpoint of productivity, for example, freeze drying, flush drying, fluidized drying, vibratory fluidized drying, or the like may be performed.

### Step of Externally Adding External Additive

For example, the manufacturing method of the toner according to the present exemplary embodiment preferably includes a step of externally adding an external additive to the toner particles.

The toner particles and the external additive in a dry state are mixed with each other to perform the external addition of the external additive to the toner particles. The mixing is performed, for example, using a V blender, a Henschel mixer, a Lödige mixer, or the like. Furthermore, coarse particles of the toner may be removed as necessary by using a vibratory sieving machine, a pneumatic sieving machine, or the like.

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂) n, Al₂O₃·2SiO₂, CaCO₃, MgCO₃, BaSO₄, and MgSO₄.

The surface of the inorganic particles as an external additive may have undergone, for example, a hydrophobic treatment. The hydrophobic treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethyl methacrylate, and melamine resins), a cleaning activator (for example, and a metal salt of a higher fatty acid represented by zinc stearate or fluorine-based polymer particles).

The amount of the external additive externally added with respect to the mass of the toner particles is, for example, preferably 0.01% by mass or more and 5% by mass or less, and more preferably 0.01% by mass or more and 2% by mass or less.

### Electrostatic Charge Image Developing Toner

The toner manufactured by the manufacturing method according to the present exemplary embodiment is, for example, an externally added toner in which an external additive is externally added to the toner particles. The aspect of the external additive is as described above.

The toner particles are toner particles having a core/shell structure, in which a core containing at least a polyester resin and a shell containing at least an amorphous polyester resin are provided. The toner particles may contain a vinyl-based resin in the core. The toner particles may contain a release agent in the core. The toner particles may contain a release agent in the shell. The toner particles may contain a colorant in the core.

The total content of the polyester resin with respect to the total amount of the toner is, for example, preferably 40% by mass or more and 95% by mass or less, more preferably 50% by mass or more and 90% by mass or less, and still more preferably 60% by mass or more and 85% by mass or less.

In a case where the toner particles contain the crystalline polyester resin, a content of the crystalline polyester resin is, for example, preferably 3% by mass or more and 30% by mass or less, and more preferably 8% by mass or more and 20% by mass or less with respect to the total amount of the binder resin.

In a case where the toner particles contain the vinyl-based resin, a content of the vinyl-based resin is, for example, preferably 1% by mass or more and 30% by mass or less, and more preferably 3% by mass or more and 20% by mass or less with respect to the total amount of the binder resin.

In a case where the toner contains the release agent, a content of the release agent is, for example, preferably 1% by mass or more and 20% by mass or less and more preferably 5% by mass or more and 15% by mass or less with respect to the total amount of the toner.

In a case where the toner contains the colorant, a content of the colorant is, for example, preferably 1% by mass or more and 30% by mass or less and more preferably 3% by mass or more and 15% by mass or less with respect to the total amount of the toner.

A volume-average particle size of the toner is, for example, preferably 2 μm or more and 10 μm or less, and more preferably 4 μm or more and 8 μm or less. A method for measuring the volume-average particle size of the toner is as follows.

A particle size distribution of the toner is measured using COULTER MULTISIZER II (manufactured by Beckman Coulter, Inc.) and using ISOTON-II (manufactured by Beckman Coulter, Inc.) as an electrolytic solution. For measurement, a measurement sample in an amount of 0.5 mg or more and 50 mg or less is added to 2 ml of a 5% by mass aqueous solution of a surfactant (for example, preferably sodium alkylbenzene sulfonate) as a dispersant. The obtained solution is added to an electrolytic solution in a volume of 100 ml or more and 150 ml or less. The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000. A particle size distribution is drawn from the small size side, and a particle size at which the cumulative percentage is 50% is defined as the volume-average particle size D50v.

An average circularity of the toner is, for example, preferably 0.94 or more and 1.00 or less, and more preferably 0.95 or more and 0.98 or less.

The average circularity of the toner is (peripheral length of circle having the same area as the particle projection image)/(peripheral length of the particle projection image). The average circularity of the toner is obtained by sampling 3,500 particles using a flow-type particle image analyzer (FPIA-3000 manufactured by Sysmex Corporation).

### Developer

The toner manufactured by the manufacturing method according to the present exemplary embodiment may be used as a one-component developer or may be used as a two-component developer by being mixed with a carrier.

The carrier is not particularly limited, and examples thereof include known carriers. Examples of the carrier include a coated carrier obtained by coating the surface of a core material consisting of magnetic powder with a resin; a magnetic powder dispersion-type carrier obtained by dispersing magnetic powder in a matrix resin and mixing the powder and the resin together; and a resin impregnation-type carrier obtained by impregnating porous magnetic powder with a resin.

The magnetic powder dispersion-type carrier or the resin impregnation-type carrier may be a carrier obtained by coating the surface of a core material, that is particles configuring the carrier, with a resin.

Examples of the magnetic powder include magnetic metals such as iron, nickel, and cobalt; and magnetic oxides such as ferrite and magnetite.

Examples of the coating resin and matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid ester copolymer, a straight silicone resin configured with an organosiloxane bond, a product obtained by modifying the straight silicone resin, a fluororesin, polyester, polycarbonate, a phenol resin, and an epoxy resin. The coating resin and the matrix resin may contain other additives such as conductive particles. Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a resin, for example, by a coating method using a solution for forming a coating layer obtained by dissolving the coating resin and various additives (used as necessary) in an appropriate solvent, and the like. The solvent is not particularly limited, and may be selected in consideration of the type of the resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and then removing solvents.

The mixing ratio (mass ratio) between the toner and the carrier, represented by toner: carrier, in the two-component developer is, for example, preferably 1:100 to 30:100, and more preferably 3:100 to 20:100.

### EXAMPLES

Hereinafter, exemplary embodiments of the invention will be specifically described based on examples. However, the exemplary embodiments of the invention are not limited to the examples.

In the following description, unless otherwise specified, “parts” and “%” are based on mass.

In the following description, the synthesis, the production, the treatment, the measurement, and the like are carried out at room temperature (25° C.±3° C.) unless otherwise specified.

### Production of Dispersion of Amorphous Polyester Resin Particles

### Production of Dispersion (1) of Amorphous Polyester Resin Particles

### Synthesis of Amorphous Polyester Resin

The following materials are prepared.
Terephthalic acid: 69 parts
Trimellitic acid: 31 parts
Ethylene glycol: 40 parts
1,5-Pentanediol: 45 parts

The above-described materials are charged into a flask equipped with an agitation device, a nitrogen introduction pipe, a temperature sensor, and a rectification column, the temperature of the reaction solution is raised to 220° C. over 1 hour under nitrogen gas stream, and 1 part of titanium tetraethoxide with respect to the total of 100 parts of the above-described materials is added thereto. While the generated water is distilled off, the temperature is raised to 240° C. over 0.5 hours, a dehydration condensation reaction is continued for 1 hour at 240° C., and then the reaction product is cooled. In this manner, an amorphous polyester resin (1) having an acid value of 12.1 mgKOH/g, a weight-average molecular weight of 127,000, and a glass transition temperature of 56° C. is obtained.

### Emulsification and Dispersion of Amorphous Polyester Resin

100 parts of the amorphous polyester resin (1), 70 parts of ethyl acetate, and 15 parts of isopropanol are charged into a reaction vessel equipped with an agitation device, a condenser, a heater, and a thermometer. The temperature in the reaction vessel is raised to 50° C., and the resin is dissolved in the organic solvent by agitating for 30 minutes while maintaining the temperature at 50° C. While agitating the resin solution, 5 parts of 10% ammonia water is added thereto, and then 330 parts of deionized water at a temperature of 40° C. is gradually added thereto to obtain an emulsion. The inside of the reaction vessel is depressurized to remove the organic solvent from the emulsion, and then 2 parts of an anionic surfactant (product name: NEOGEN RK, DKS Co. Ltd.; aqueous solution with a concentration of 20%) is added thereto to obtain a dispersion (1) of amorphous polyester resin particles, having a concentration of solid contents of 35%. A volume-average particle size of the particles in the dispersion (1) of amorphous polyester resin particles is 180 nm.

In Examples described below, in a case where the dispersion (1) of amorphous polyester resin particles is used in the second aggregation step, the dispersion is diluted or concentrated as necessary to adjust the concentration of solid contents as shown in Table 1, thereby preparing a dispersion for shell formation.

### Production of Dispersion (2) of Amorphous Polyester Resin Particles

### Synthesis of Amorphous Polyester Resin

The following materials are prepared.
Terephthalic acid: 69 parts
Trimellitic acid: 31 parts
Ethylene glycol: 48 parts
1,5-Pentanediol: 47 parts

The above-described materials are charged into a flask equipped with an agitation device, a nitrogen introduction pipe, a temperature sensor, and a rectification column, the temperature of the reaction solution is raised to 220° C. over 1 hour under nitrogen gas stream, and 1 part of titanium tetraethoxide with respect to the total of 100 parts of the above-described materials is added thereto. While the generated water is distilled off, the temperature is raised to 240° C. over 0.5 hours, a dehydration condensation reaction is continued for 1 hour at 240° C., and then the reaction product is cooled. In this manner, an amorphous polyester resin (2) having an acid value of 8.0 mgKOH/g, a weight-average molecular weight of 139,000, and a glass transition temperature of 56° C. is obtained.

### Emulsification and Dispersion of Amorphous Polyester Resin

100 parts of the amorphous polyester resin (2), 70 parts of ethyl acetate, and 15 parts of isopropanol are charged into a reaction vessel equipped with an agitation device, a condenser, a heater, and a thermometer. The temperature in the reaction vessel is raised to 50° C., and the resin is dissolved in the organic solvent by agitating for 30 minutes while maintaining the temperature at 50° C. While agitating the resin solution, 5 parts of 10% ammonia water is added thereto, and then 330 parts of deionized water at a temperature of 40° C. is gradually added thereto to obtain an emulsion. The inside of the reaction vessel is depressurized to remove the organic solvent from the emulsion, and then 2 parts of an anionic surfactant (product name: NEOGEN RK, DKS Co. Ltd.; aqueous solution with a concentration of 20%) is added thereto to obtain a dispersion (2) of amorphous polyester resin particles, having a concentration of solid contents of 35%. A volume-average particle size of the particles in the dispersion (2) of amorphous polyester resin particles is 180 nm.

In Examples described below, in a case where the dispersion (2) of amorphous polyester resin particles is used in the second aggregation step, the dispersion is diluted or concentrated as necessary to adjust the concentration of solid contents as shown in Table 1, thereby preparing a dispersion for shell formation.

### Production of Dispersion (3) of Amorphous Polyester Resin Particles

### Synthesis of Amorphous Polyester Resin

The following materials are prepared.
Terephthalic acid: 69 parts
Trimellitic acid: 31 parts
Ethylene glycol: 36 parts
1,5-Pentanediol: 39 parts

The above-described materials are charged into a flask equipped with an agitation device, a nitrogen introduction pipe, a temperature sensor, and a rectification column, the temperature of the reaction solution is raised to 220° C. over 1 hour under nitrogen gas stream, and 1 part of titanium tetraethoxide with respect to the total of 100 parts of the above-described materials is added thereto. While the generated water is distilled off, the temperature is raised to 240° C. over 0.5 hours, a dehydration condensation reaction is continued for 1 hour at 240° C., and then the reaction product is cooled. In this manner, an amorphous polyester resin (3) having an acid value of 16.0 mgKOH/g, a weight-average molecular weight of 116,000, and a glass transition temperature of 56° C. is obtained.

### Emulsification and Dispersion of Amorphous Polyester Resin

100 parts of the amorphous polyester resin (3), 70 parts of ethyl acetate, and 15 parts of isopropanol are charged into a reaction vessel equipped with an agitation device, a condenser, a heater, and a thermometer. The temperature in the reaction vessel is raised to 50° C., and the resin is dissolved in the organic solvent by agitating for 30 minutes while maintaining the temperature at 50° C. While agitating the resin solution, 5 parts of 10% ammonia water is added thereto, and then 330 parts of deionized water at a temperature of 40° C. is gradually added thereto to obtain an emulsion. The inside of the reaction vessel is depressurized to remove the organic solvent from the emulsion, and then 2 parts of an anionic surfactant (product name: NEOGEN RK, DKS Co. Ltd.; aqueous solution with a concentration of 20%) is added thereto to obtain a dispersion (3) of amorphous polyester resin particles, having a concentration of solid contents of 35%. A volume-average particle size of the particles in the dispersion (3) of amorphous polyester resin particles is 180 nm.

In Examples described below, in a case where the dispersion (3) of amorphous polyester resin particles is used in the second aggregation step, the dispersion is diluted or concentrated as necessary to adjust the concentration of solid contents as shown in Table 1, thereby preparing a dispersion for shell formation.

### Production of Dispersion (1) of Crystalline Polyester Resin Particles

### Synthesis of Crystalline Polyester Resin

The following materials are prepared.
Succinic acid: 48 parts by mole
1,5-Pentanediol: 52 parts by mole
·Dibutyltin oxide: 0.08 parts by mole

The above-described materials are charged into an agitated vessel, mixed, the temperature in the agitating layer is raised to 220° C. in a reduced pressure atmosphere, and a dehydration condensation reaction is performed for 6 hours to obtain a crystalline polyester resin (1).

### Dispersion of Crystalline Polyester Resin

The following materials are prepared.
Crystalline polyester resin (1): 80 parts
Deionized water: 720 parts
Anionic surfactant (product name: NEOGEN RK, DKS Co. Ltd., aqueous solution with a concentration of 20%): 1.8 parts

The above-described materials are mixed with each other, heated to 55° C., and then subjected to a dispersion treatment using a homogenizer (ULTRA-TURRAX T50, IKA) and a pressure jet-type homogenizer (Manton-Gaulin high-pressure homogenizer, Gaulin Corporation). At a point in time when the volume-average particle size reaches 160 nm, the dispersed resultant is collected, thereby obtaining a dispersion (1) of crystalline polyester resin particles, having a concentration of solid contents of 10%.

### Production of Vinyl-based Resin Particle Dispersion

### Production of Vinyl-based Resin Particle Dispersion (1)

### Production of Emulsion (1-1)

The following materials are prepared.
Styrene: 5.5 parts
n-Butyl acrylate: 4.5 parts
Dodecanethiol: 0.05 parts
Deionized water: 500 parts
Anionic surfactant (product name: Newcol 271A, Nippon Nyukazai Co., Ltd.): 4 parts

The above-described materials are charged into a reactor equipped with a reflux condenser, an agitation device, a nitrogen introduction pipe, and a monomer dropping port, and the materials are agitated at room temperature to be emulsified, thereby obtaining an emulsion (1-1).

### Production of Emulsion (1-2)

The following materials are prepared.
Styrene: 385 parts
n-Butyl acrylate: 203 parts
Dodecanethiol: 2 parts
Deionized water: 846 parts
Anionic surfactant (product name: Newcol 271A, Nippon Nyukazai Co., Ltd.): 4 parts

The above-described materials are charged into a reactor equipped with an agitation device, and the materials are agitated at room temperature to be emulsified, thereby obtaining an emulsion (1-2).

### Formation of Vinyl-Based Resin Particles

After obtaining the emulsion (1-1), nitrogen substitution is performed inside the reactor. Furthermore, the temperature is raised to 75° C. while introducing nitrogen into the reactor, 50 parts of a 10% ammonium persulfate aqueous solution is added thereto, and the mixture is kept for 20 minutes. Next, the emulsion (1-2) is added dropwise thereto from the monomer dropping port of the reactor over 2 hours while maintaining the temperature at 75° C. and continuing the agitating. 30 minutes after the completion of the dropwise addition of the emulsion (1-2), 5 parts of a 10% ammonium persulfate aqueous solution is added thereto, and further 30 minutes later, 5 parts of a 10% ammonium persulfate aqueous solution is added thereto. The agitating is continued for 1.5 hours while maintaining the temperature at 75° C. Thereafter, the inside of the reactor is cooled to room temperature, and the concentration of solid contents is adjusted to 30%, thereby obtaining a vinyl-based resin particle dispersion (1). A volume-average particle size of the particles in the vinyl-based resin particle dispersion (1) is 140 nm.

### Production of Vinyl-Based Resin Particle Dispersion (2)

### Production of Emulsion (2-1)

The following materials are prepared.
Styrene: 6 parts
n-Butyl acrylate: 4 parts
Dodecanethiol: 0.05 parts
Deionized water: 500 parts
Anionic surfactant (product name: Newcol 271A, Nippon Nyukazai Co., Ltd.): 4 parts

The above-described materials are charged into a reactor equipped with a reflux condenser, an agitation device, a nitrogen introduction pipe, and a monomer dropping port, and the materials are agitated at room temperature to be emulsified, thereby obtaining an emulsion (2-1).

### Production of Emulsion (2-2)

The following materials are prepared.
Styrene: 415 parts
n-Butyl acrylate: 173 parts
Dodecanethiol: 2 parts
Deionized water: 846 parts
Anionic surfactant (product name: Newcol 271A, Nippon Nyukazai Co., Ltd.): 4 parts

The above-described materials are charged into a reactor equipped with an agitation device, and the materials are agitated at room temperature to be emulsified, thereby obtaining an emulsion (2-2).

### Formation of Vinyl-Based Resin Particles

After obtaining the emulsion (2-1), nitrogen substitution is performed inside the reactor. Furthermore, the temperature is raised to 75° C. while introducing nitrogen into the reactor, 50 parts of a 10% ammonium persulfate aqueous solution is added thereto, and the mixture is kept for 20 minutes. Next, the emulsion (2-2) is added dropwise thereto from the monomer dropping port of the reactor over 2 hours while maintaining the temperature at 75° C. and continuing the agitating. 30 minutes after the completion of the dropwise addition of the emulsion (2-2), 5 parts of a 10% ammonium persulfate aqueous solution is added thereto, and further 30 minutes later, 5 parts of a 10% ammonium persulfate aqueous solution is added thereto. The agitating is continued for 1.5 hours while maintaining the temperature at 75° C. Thereafter, the inside of the reactor is cooled to room temperature, and the concentration of solid contents is adjusted to 30%, thereby obtaining a vinyl-based resin particle dispersion (2). A volume-average particle size of the particles in the vinyl-based resin particle dispersion (2) is 140 nm.

### Production of Vinyl-Based Resin Particle Dispersion (3)

### Production of Emulsion (3-1)

The following materials are prepared.
Styrene: 8 parts
n-Butyl acrylate: 2 parts
Dodecanethiol: 0.05 parts
Deionized water: 500 parts
Anionic surfactant (product name: Newcol 271A, Nippon Nyukazai Co., Ltd.): 4 parts

The above-described materials are charged into a reactor equipped with a reflux condenser, an agitation device, a nitrogen introduction pipe, and a monomer dropping port, and the materials are agitated at room temperature to be emulsified, thereby obtaining an emulsion (3-1).

### Production of Emulsion (3-2)

The following materials are prepared.

Styrene: 470 parts
n-Butyl acrylate: 118 parts
Dodecanethiol: 2 parts
Deionized water: 846 parts
Anionic surfactant (product name: Newcol 271A, Nippon Nyukazai Co., Ltd.): 4 parts

The above-described materials are charged into a reactor equipped with an agitation device, and the materials are agitated at room temperature to be emulsified, thereby obtaining an emulsion (3-2).

### Formation of Vinyl-Based Resin Particles

After obtaining the emulsion (3-1), nitrogen substitution is performed inside the reactor. Furthermore, the temperature is raised to 75° C. while introducing nitrogen into the reactor, 50 parts of a 10% ammonium persulfate aqueous solution is added thereto, and the mixture is kept for 20 minutes. Next, the emulsion (3-2) is added dropwise thereto from the monomer dropping port of the reactor over 2 hours while maintaining the temperature at 75° C. and continuing the agitating. 30 minutes after the completion of the dropwise addition of the emulsion (3-2), 5 parts of a 10% ammonium persulfate aqueous solution is added thereto, and further 30 minutes later, 5 parts of a 10% ammonium persulfate aqueous solution is added thereto. The agitating is continued for 1.5 hours while maintaining the temperature at 75° C. Thereafter, the inside of the reactor is cooled to room temperature, and the concentration of solid contents is adjusted to 30%, thereby obtaining a vinyl-based resin particle dispersion (3). A volume-average particle size of the particles in the vinyl-based resin particle dispersion (3) is 140 nm.

### Production of Vinyl-Based Resin Particle Dispersion (4)

### Production of Emulsion (4-1)

The following materials are prepared.
Styrene: 8.5 parts
n-Butyl acrylate: 1.5 parts
Dodecanethiol: 0.05 parts
Deionized water: 500 parts.
Anionic surfactant (product name: Newcol 271A, Nippon Nyukazai Co., Ltd.): 4 parts

The above-described materials are charged into a reactor equipped with a reflux condenser, an agitation device, a nitrogen introduction pipe, and a monomer dropping port, and the materials are agitated at room temperature to be emulsified, thereby obtaining an emulsion (4-1).

### Production of Emulsion (4-2)

The following materials are prepared.
Styrene: 492 parts
n-Butyl acrylate: 96 parts
Dodecanethiol: 2 parts
Deionized water: 846 parts
Anionic surfactant (product name: Newcol 271A, Nippon Nyukazai Co., Ltd.): 4 parts

The above-described materials are charged into a reactor equipped with an agitation device, and the materials are agitated at room temperature to be emulsified, thereby obtaining an emulsion (4-2).

### Formation of Vinyl-Based Resin Particles

After obtaining the emulsion (4-1), nitrogen substitution is performed inside the reactor. Furthermore, the temperature is raised to 75° C. while introducing nitrogen into the reactor, 50 parts of a 10% ammonium persulfate aqueous solution is added thereto, and the mixture is kept for 20 minutes. Next, the emulsion (4-2) is added dropwise thereto from the monomer dropping port of the reactor over 2 hours while maintaining the temperature at 75° C. and continuing the agitating. 30 minutes after the completion of the dropwise addition of the emulsion (4-2), 5 parts of a 10% ammonium persulfate aqueous solution is added thereto, and further 30 minutes later, 5 parts of a 10% ammonium persulfate aqueous solution is added thereto. The agitating is continued for 1.5 hours while maintaining the temperature at 75° C. Thereafter, the inside of the reactor is cooled to room temperature, and the concentration of solid contents is adjusted to 30%, thereby obtaining a vinyl-based resin particle dispersion (4). A volume-average particle size of the particles in the vinyl-based resin particle dispersion (4) is 140 nm.

### Production of Release Agent Particle Dispersion (1)

The following materials are prepared.
Paraffin wax (melting point: 92° C., product name: FNP92, NIPPON SEIRO CO., LTD.): 87 parts
Deionized water: 200 parts
Anionic surfactant (product name: NEOGEN RK, DKS Co. Ltd., aqueous solution with a concentration of 20%): 3 parts

The above-described materials are mixed with each other, heated to 95° C., and then subjected to a dispersion treatment using a homogenizer (ULTRA-TURRAX T50, IKA) and a pressure jet-type homogenizer (Manton-Gaulin high-pressure homogenizer, Gaulin Corporation). At a point in time when the volume-average particle size reaches 190 nm, the dispersed resultant is collected, thereby obtaining a release agent particle dispersion (1), having a concentration of solid contents of 30%.

### Production of Colorant Particle Dispersion

### Production of Colorant Particle Dispersion (1)

The following materials are prepared.
Carbon black (product name: #25B, Mitsubishi Chemical Corporation): 20 parts
Deionized water: 80 parts
Anionic surfactant (product name: NEOGEN RK, DKS Co. Ltd., aqueous solution with a concentration of 20%): 2 parts

The above-described materials are mixed and dispersed using a high-pressure impact disperser (product name: ULTIMIZER HJP30006, SUGINO MACHINE LIMITED). At a point in time when the volume-average particle size reaches 180 nm, the dispersed resultant is collected, thereby obtaining a colorant particle dispersion (1), having a concentration of solid contents of 20%.

A part of the colorant particle dispersion (1) is taken, and a zeta potential thereof is measured using a zeta potential measurement system (product name: ELSZ-2000ZS, Otsuka Electronics Co., Ltd.) with an adjustment of a concentration of solid contents of 10%, a pH of 6, and a temperature of 25° C. The zeta potential is −25 mV.

### Production of Colorant Particle Dispersion (2)

The following materials are prepared.
Carbon black (product name: #25B, Mitsubishi Chemical Corporation): 20 parts
Deionized water: 80 parts
Anionic surfactant (product name: NEOGEN RK, DKS Co. Ltd., aqueous solution: 6 parts with a concentration of 20%)

The above-described materials are mixed and dispersed using a high-pressure impact disperser (product name: ULTIMIZER HJP30006, SUGINO MACHINE LIMITED). At a point in time when the volume-average particle size reaches 250 nm, the dispersed resultant is collected, thereby obtaining a colorant particle dispersion (2), having a concentration of solid contents of 20%.

A part of the colorant particle dispersion (2) is taken, and a zeta potential thereof is measured using a zeta potential measurement system (product name: ELSZ-2000ZS, Otsuka Electronics Co., Ltd.) with an adjustment of a concentration of solid contents of 10%, a pH of 6, and a temperature of 25° C. The zeta potential is −45 mV.

### Production of Colorant Particle Dispersion (3)

The following materials are prepared.
Carbon black (product name: #25B, Mitsubishi Chemical Corporation): 20 parts
Deionized water: 80 parts
Anionic surfactant (product name: NEOGEN RK, DKS Co. Ltd., aqueous solution with a concentration of 20%): 5 parts

The above-described materials are mixed and dispersed using a high-pressure impact disperser (product name: ULTIMIZER HJP30006, SUGINO MACHINE LIMITED). At a point in time when the volume-average particle size reaches 220 nm, the dispersed resultant is collected, thereby obtaining a colorant particle dispersion (3), having a concentration of solid contents of 20%.

A part of the colorant particle dispersion (3) is taken, and a zeta potential thereof is measured using a zeta potential measurement system (product name: ELSZ-2000ZS, Otsuka Electronics Co., Ltd.) with an adjustment of a concentration of solid contents of 10%, a pH of 6, and a temperature of 25° C. The zeta potential is −40 mV.

### Production of Colorant Particle Dispersion (4)

The following materials are prepared.
Carbon black (product name: #25B, Mitsubishi Chemical Corporation): 20 parts
Deionized water: 80 parts
Anionic surfactant (product name: NEOGEN RK, DKS Co. Ltd., aqueous solution with a concentration of 20%): 1.5 parts

The above-described materials are mixed and dispersed using a high-pressure impact disperser (product name: ULTIMIZER HJP30006, SUGINO MACHINE LIMITED). At a point in time when the volume-average particle size reaches 130 nm, the dispersed resultant is collected, thereby obtaining a colorant particle dispersion (4), having a concentration of solid contents of 20%.

A part of the colorant particle dispersion (4) is taken, and a zeta potential thereof is measured using a zeta potential measurement system (product name: ELSZ-2000ZS, Otsuka Electronics Co., Ltd.) with an adjustment of a concentration of solid contents of 10%, a pH of 6, and a temperature of 25° C. The zeta potential is −15 mV.

### Production of Colorant Particle Dispersion (5)

The following materials are prepared.
Carbon black (product name: #25B, Mitsubishi Chemical Corporation): 20 parts
Deionized water: 80 parts
Anionic surfactant (product name: NEOGEN RK, DKS Co. Ltd., aqueous solution with a concentration of 20%): 1 part

The above-described materials are mixed and dispersed using a high-pressure impact disperser (product name: ULTIMIZER HJP30006, SUGINO MACHINE LIMITED). At a point in time when the volume-average particle size reaches 110 nm, the dispersed resultant is collected, thereby obtaining a colorant particle dispersion (5), having a concentration of solid contents of 20%.

A part of the colorant particle dispersion (5) is taken, and a zeta potential thereof is measured using a zeta potential measurement system (product name: ELSZ-2000ZS, Otsuka Electronics Co., Ltd.) with an adjustment of a concentration of solid contents of 10%, a pH of 6, and a temperature of 25° C. The zeta potential is −12 mV.

Examples of manufacturing examples of a toner and a developer are shown below. In Examples and Comparative Examples below, a target charge amount of the developer is −43 μC/g, and a target particle size of the toner particles is 5.0 μm.

### Example 1

### Production of Toner Particles

The following materials are prepared.
Deionized water: 235 parts
Dispersion (1) of amorphous polyester resin particles: 170 parts
Dispersion (1) of crystalline polyester resin particles: 100 parts
Release agent particle dispersion (1): 25 parts
Colorant particle dispersion (1): 50 parts
Anionic surfactant (TaycaPower): 3.0 parts

### First Aggregation Step

The above-described materials are charged into an agitated vessel provided with a jacket and an agitation blade to prepare a mixed dispersion having a concentration of solid contents of 15%. 0.1 N nitric acid is added to the mixed dispersion to adjust the pH to 3.5. Next, an aluminum sulfate aqueous solution (aqueous solution obtained by dissolving 2 parts of aluminum sulfate in 30 parts of deionized water) is added thereto, and the mixture is dispersed using a homogenizer. Next, the liquid temperature in the agitated vessel is raised to 45° C. to form first aggregated particles. The liquid temperature is maintained at 45° C. until a volume-average particle size of the first aggregated particles reaches 4.0 μm.

### Second Aggregation Step

A dispersion for shell formation is prepared by adjusting the temperature and the concentration of the dispersion (1) of amorphous polyester resin particles to have the temperature Ts and the concentration Ws shown in Table 1.

120 parts of the dispersion for shell formation is added to the agitated vessel while maintaining the liquid temperature in the agitated vessel (that is, the temperature Tc of the dispersion containing the first aggregated particles) at 45° C. The solution is kept for 30 minutes while agitating the solution at (P−P0) of agitation blade=1.2 kW/m³ to form second aggregated particles. 20 parts of a 10% nitrilotriacetic acid (NTA) metal salt aqueous solution (product name: CHELEST 70, Chelest Corporation) is added to the agitated vessel, and a 1 N sodium hydroxide aqueous solution is added thereto to adjust the pH to 9.0, thereby stopping the growth of the second aggregated particles.

### Coalescence Step

1 part of an anionic surfactant (TaycaPower) is added to the agitated vessel, and the mixture is heated to 85° C. while being continuously agitated and retained for 5 hours. Next, the temperature is lowered to 20° C. at a rate of 20° C./min.

The toner particle dispersion is put into a filter press (manufactured by Tokyo Engineering Corporation), and compressed at a pressure of 0.4 MPa to form a cake. The cake is washed with 1500% of water with respect to the cake amount. The cake after the washing is dried using an air stream dryer, and the dried product is sieved to obtain toner particles (1).

### Production of Externally Added Toner

2 parts of hydrophobic silica particles (product number: RY50, NIPPON AEROSIL CO., LTD.) is added to 100 parts of the toner particles (1), and the mixture is mixed using a sample mill at 10,000 rpm for 30 seconds. Thereafter, the mixture is sieved using a vibration sieve having an opening size of 45 μm, thereby obtaining an externally added toner.

### Production of Developer

8 parts of the externally added toner and 92 parts of a carrier (1) shown below are charged into a V blender and agitated for 20 minutes. Thereafter, the mixture is sieved using a sieve having an opening size of 212 μm, thereby obtaining a developer.

### Production of Carrier (1)

14 parts of toluene, 5 parts of polymethyl methacrylate (weight-average molecular weight: 75,000), and 0.2 parts of carbon black (product number: VXC-72, Cabot Corporation) are charged into a sand mill and dispersed to prepare a dispersion. The dispersion and 100 parts of ferrite particles (average particle size: 35 μm) are placed in a vacuum deaeration kneader, and while agitating, the mixture is dried under reduced pressure to obtain the carrier (1).

### Examples 2 to 4

Toner particles, an externally added toner, and a developer are produced in the same manner as in Example 1, except that the temperature Tc and the concentration Wc of the first aggregated particle dispersion used in the second aggregation step and the temperature Ts and the concentration Ws of the dispersion for shell formation (amorphous polyester resin particle dispersion) are changed as shown in Table 1.

### Examples 5 and 6

Each of toner particles, an externally added toner, and a developer is produced in the same manner as in Example 1, except that the temperature Tc of the first aggregated particle dispersion used in the second aggregation step and the temperature Ts of the dispersion for shell formation (amorphous polyester resin particle dispersion) are changed as shown in Table 1.

### Examples 7 and 8

Each of toner particles, an externally added toner, and a developer is produced in the same manner as in Example 1, except that the agitation power (P−P0) per unit volume in the second aggregation step is changed as shown in Table 1.

### Examples 9 and 10

Each of the toner particles, the externally added toner, and the developer is produced in the same manner as in Example 1, except that the type of the dispersion for shell formation (amorphous polyester resin particle dispersion) is changed as shown in Table 1.

### Examples 11 to 18

Each of toner particles, an externally added toner, and a developer is produced in the same manner as in Example 1, except that the concentration Wc of the first aggregated particle dispersion used in the second aggregation step and the concentration Ws of the dispersion for shell formation (amorphous polyester resin particle dispersion) are changed as shown in Table 1.

### Examples 19 and 20

Each of toner particles, an externally added toner, and a developer is produced in the same manner as in Example 1, except that the addition amounts of the dispersion (1) of amorphous polyester resin particles and the dispersion (1) of crystalline polyester resin particles are changed so that the proportion of the polyester resin particles in the total solid content in the first aggregation step is as shown in Table 1 (provided that, the amount ratio of both is the same as in Examples).

### Examples 21 to 24

Each of the toner particles, the externally added toner, and the developer is produced in the same manner as in Example 1, except that the type of the colorant particle dispersion is changed as shown in Table 1.

### Examples 25 to 28

Toner particles, an externally added toner, and a developer are produced in the same manner as in Example 1, except that 50 parts of any of the vinyl-based resin particle dispersions (1) to (4) is used in the first aggregation step.

### Example 29

Toner particles, an externally added toner, and a developer are produced in the same manner as in Example 1, except that 50 parts of the vinyl-based resin particle dispersion (1) is used in the first aggregation step, the dispersion for shell formation, used in the second aggregation step, is mixed with 100 parts of the dispersion (1) of amorphous polyester resin particles and 20 parts of the release agent particle dispersion (1), and a dispersion for shell formation in which the temperature Ts and the concentration Ws thereof is changed as shown in Table 1 is used.

### Comparative Examples 1 and 2

Each of toner particles, an externally added toner, and a developer is produced in the same manner as in Example 1, except that the temperature Tc of the first aggregated particle dispersion used in the second aggregation step is changed as shown in Table 1.

### Comparative Examples 3 and 4

Each of toner particles, an externally added toner, and a developer is produced in the same manner as in Example 1, except that the temperature Ts of the dispersion for shell formation (amorphous polyester resin particle dispersion) used in the second aggregation step is changed as shown in Table 1.

### Comparative Examples 5 and 6

Each of toner particles, an externally added toner, and a developer is produced in the same manner as in Example 1, except that the agitation power (P−P0) per unit volume in the second aggregation step is changed as shown in Table 1.

### Performance Evaluation

### Particle Size Distribution of Toner Particles

The particle size distribution of the toner particles is measured using COULTER MULTISIZER II (Beckman Coulter, Inc.), and a volume-average particle size and the number proportion of particles having a particle size of 2 μm or less are obtained. The number proportion of particles having a particle size of 2 μm or less is classified as follows. The results are shown in Table 1.
A: 5% or less
B: more than 5% and 8% or less
C: more than 8% and 10% or less
D: more than 10%

### Charge Amount of Developer

The developer is allowed to stand in an environment of a temperature of 20° C. and a relative humidity of 50% for one night. In the same environment, 7.5 g of the developer is put into a Turbula mixer and agitated, and the charge amount (μC/g) of the developer after agitating for 10 seconds is measured with a blow-off charge amount measuring device. The difference with the target charge amount of the developer of −43 μC/g of is classified as follows. The results are shown in Table 1.
A: ±3 μC/g or less
A−: more than +3 μC/g and +5 μC/g or less
B: more than +5 μC/g and +7 μC/g or less
C: more than +7 μC/g and +10 μC/g or less
D: more than +10 μC/g

“ΔSP value” in Table 1 means a difference between the solubility parameter of the vinyl-based resin used in the first aggregation step and the solubility parameter of the amorphous polyester resin used in the second aggregation step.

TABLE 1

| | | | | | | | | | | | First aggregation step | | |
|---|---|---|---|---|---|---|---|---|---|---|---|---|---|
| | | | | Second aggregation step | | | | | | | Proportion | | |
| | | | | | | | | First | | | of | | |
| | | | | First | | | | aggregated | Dispersion | | polyester | | |
| | | | | aggregated | | | | particle | for shell | | resin in | | |
| | Amorphous | | | particle | Dispersion for | | | dispersion | formation | | total solid | Colorant | |
| | polyester resin | | | dispersion | shell formation | | | Concen- | Concen- | | content of | particle | |
| | and particle dispersion | | | Temper- | Temper- | | | tration | tration | Ws − | mixed | dispersion | |
| | | Acid | | ature | ature | Release | | Wc | Ws | Wc | dispersion | | Zeta |
| | Name | value | Tgs | Tc | Ts | agent | P − P0 | % by | % by | % by | % by | Name | potential |
| | — | mgKOH/g | ° C. | ° C. | ° C. | — | kW/m³ | mass | mass | mass | mass | — | mV |
| Comparative | (1) | 12.1 | 56 | 32 | 20 | — | 1.2 | 15 | 30 | 15 | 80 | (1) | −25 |
| Example 1 | | | | | | | | | | | | | |
| Comparative | (1) | 12.1 | 56 | 53 | 20 | — | 1.2 | 15 | 30 | 15 | 80 | (1) | −25 |
| Example 2 | | | | | | | | | | | | | |
| Comparative | (1) | 12.1 | 56 | 45 | 9 | — | 1.2 | 15 | 30 | 15 | 80 | (1) | −25 |
| Example 3 | | | | | | | | | | | | | |
| Comparative | (1) | 12.1 | 56 | 45 | 46 | — | 1.2 | 15 | 30 | 15 | 80 | (1) | −25 |
| Example 4 | | | | | | | | | | | | | |
| Comparative | (1) | 12.1 | 56 | 45 | 20 | — | 0.45 | 15 | 30 | 15 | 80 | (1) | −25 |
| Example 5 | | | | | | | | | | | | | |
| Comparative | (1) | 12.1 | 56 | 45 | 20 | — | 3.2 | 15 | 30 | 15 | 80 | (1) | −25 |
| Example 6 | | | | | | | | | | | | | |
| Example 1 | (1) | 12.1 | 56 | 45 | 20 | — | 1.2 | 15 | 30 | 15 | 80 | (1) | −25 |
| Example 2 | (1) | 12.1 | 56 | 35 | 20 | — | 1.2 | 15 | 30 | 15 | 80 | (1) | −25 |
| Example 3 | (1) | 12.1 | 56 | 51 | 20 | — | 1.2 | 15 | 30 | 15 | 80 | (1) | −25 |
| Example 4 | (1) | 12.1 | 56 | 42 | 15 | — | 1.2 | 13 | 25 | 12 | 80 | (1) | −25 |
| Example 5 | (1) | 12.1 | 56 | 35 | 10 | — | 1.2 | 15 | 30 | 15 | 80 | (1) | −25 |
| Example 6 | (1) | 12.1 | 56 | 51 | 51 | — | 1.2 | 15 | 30 | 15 | 80 | (1) | −25 |
| Example 7 | (1) | 12.1 | 56 | 45 | 20 | — | 0.6 | 15 | 30 | 15 | 80 | (1) | −25 |
| Example 8 | (1) | 12.1 | 56 | 45 | 20 | — | 3.0 | 15 | 30 | 15 | 80 | (1) | −25 |
| Example 9 | (2) | 8.0 | 56 | 45 | 20 | — | 1.2 | 15 | 30 | 15 | 80 | (1) | −25 |
| Example 10 | (3) | 16.0 | 56 | 45 | 20 | — | 1.2 | 15 | 30 | 15 | 80 | (1) | −25 |
| Example 11 | (1) | 12.1 | 56 | 45 | 20 | — | 1.2 | 9 | 25 | 16 | 80 | (1) | −25 |
| Example 12 | (1) | 12.1 | 56 | 45 | 20 | — | 1.2 | 10 | 25 | 15 | 80 | (1) | −25 |
| Example 13 | (1) | 12.1 | 56 | 45 | 20 | — | 1.2 | 20 | 35 | 15 | 80 | (1) | −25 |
| Example 14 | (1) | 12.1 | 56 | 45 | 20 | — | 1.2 | 22 | 35 | 13 | 80 | (1) | −25 |
| Example 15 | (1) | 12.1 | 56 | 45 | 20 | — | 1.2 | 9 | 12 | 3 | 80 | (1) | −25 |
| Example 16 | (1) | 12.1 | 56 | 45 | 20 | — | 1.2 | 10 | 15 | 5 | 80 | (1) | −25 |
| Example 17 | (1) | 12.1 | 56 | 45 | 20 | — | 1.2 | 20 | 40 | 20 | 80 | (1) | −25 |
| Example 18 | (1) | 12.1 | 56 | 45 | 20 | — | 1.2 | 22 | 43 | 21 | 80 | (1) | −25 |
| Example 19 | (1) | 12.1 | 56 | 45 | 20 | — | 1.2 | 15 | 30 | 15 | 43 | (1) | −25 |
| Example 20 | (1) | 12.1 | 56 | 45 | 20 | — | 1.2 | 15 | 30 | 15 | 45 | (1) | −25 |
| Example 21 | (1) | 12.1 | 56 | 45 | 20 | — | 1.2 | 15 | 30 | 15 | 80 | (2) | −45 |
| Example 22 | (1) | 12.1 | 56 | 45 | 20 | — | 1.2 | 15 | 30 | 15 | 80 | (3) | −40 |
| Example 23 | (1) | 12.1 | 56 | 45 | 20 | — | 1.2 | 15 | 30 | 15 | 80 | (4) | −15 |
| Example 24 | (1) | 12.1 | 56 | 45 | 20 | — | 1.2 | 15 | 30 | 15 | 80 | (5) | −12 |
| Example 25 | (1) | 12.1 | 56 | 45 | 20 | — | 1.2 | 15 | 30 | 15 | 80 | (1) | −25 |
| Example 26 | (1) | 12.1 | 56 | 45 | 20 | — | 1.2 | 15 | 30 | 15 | 80 | (1) | −25 |
| Example 27 | (1) | 12.1 | 56 | 45 | 20 | — | 1.2 | 15 | 30 | 15 | 80 | (1) | −25 |
| Example 28 | (1) | 12.1 | 56 | 45 | 20 | — | 1.2 | 15 | 30 | 15 | 80 | (1) | −25 |
| Example 29 | (1) | 12.1 | 56 | 45 | 20 | (1) | 1.2 | 15 | 30 | 15 | 80 | (1) | −25 |

| | First aggregation step | | Toner particles | | | | |
|---|---|---|---|---|---|---|---|
| | Vinyl-based resin and | | Volume- | Proportion of | | | |
| | particle dispersion | | average | particles having 2 | | Developer | |
| | | ΔSP | particle | μm or less | | Charge amount | |
| | Name | value | size | % by | Classifi- | | Classifi- |
| | — | (cal/cm³)^{0.5} | μm | number | cation | μC/g | cation |
| Comparative | — | — | 4.2 | 13.4 | D | −56 | D |
| Example 1 | | | | | | | |
| Comparative | — | — | 5.7 | 0.7 | A | −30 | D |
| Example 2 | | | | | | | |
| Comparative | — | — | 4.3 | 11.5 | D | −54 | D |
| Example 3 | | | | | | | |
| Comparative | — | — | 5.6 | 1.5 | A | −31 | D |
| Example 4 | | | | | | | |
| Comparative | — | — | 6.0 | 1.1 | A | −29 | D |
| Example 5 | | | | | | | |
| Comparative | — | — | 4.1 | 14.2 | D | −55 | D |
| Example 6 | | | | | | | |
| Example 1 | — | — | 5.0 | 2.2 | A | −43 | A |
| Example 2 | — | — | 4.6 | 6.3 | B | −48 | A− |
| Example 3 | — | — | 5.3 | 1.8 | A | −39 | A− |
| Example 4 | — | — | 4.8 | 4.5 | A | −45 | A |
| Example 5 | — | — | 4.4 | 8.4 | C | −51 | C |
| Example 6 | — | — | 5.5 | 0.4 | A | −33 | C |
| Example 7 | — | — | 5.4 | 0.9 | A | −33 | C |
| Example 8 | — | — | 4.4 | 9.1 | C | −51 | C |
| Example 9 | — | — | 5.2 | 1.1 | A | −39 | A− |
| Example 10 | — | — | 4.7 | 4.8 | A | −46 | A |
| Example 11 | — | — | 5.4 | 6.5 | B | −36 | B |
| Example 12 | — | — | 5.3 | 5.8 | B | −37 | B |
| Example 13 | — | — | 4.8 | 1.9 | A | −46 | A |
| Example 14 | — | — | 4.7 | 1.1 | A | −49 | B |
| Example 15 | — | — | 5.6 | 8.7 | C | −36 | B |
| Example 16 | — | — | 5.5 | 7.8 | B | −37 | B |
| Example 17 | — | — | 4.8 | 1.2 | A | −46 | A |
| Example 18 | — | — | 4.9 | 0.4 | A | −49 | B |
| Example 19 | — | — | 4.6 | 6.1 | B | −49 | B |
| Example 20 | — | — | 4.7 | 4.3 | B | −46 | A |
| Example 21 | — | — | 4.5 | 7.0 | B | −48 | A− |
| Example 22 | — | — | 4.6 | 5.4 | B | −49 | B |
| Example 23 | — | — | 5.0 | 2.0 | A | −41 | A |
| Example 24 | — | — | 5.2 | 1.1 | A | −39 | A− |
| Example 25 | (1) | 0.0 | 5.0 | 2.8 | A | −42 | A |
| Example 26 | (2) | 0.4 | 4.9 | 4.3 | A | −44 | A |
| Example 27 | (3) | 1.0 | 4.6 | 6.4 | B | −48 | A− |
| Example 28 | (4) | 1.3 | 4.5 | 8.1 | C | −50 | B |
| Example 29 | (1) | 0.0 | 5.0 | 2.5 | A | −42 | A |

The manufacturing method of an electrostatic charge image developing toner according to the present disclosure includes the following aspects.

(((1)))

A manufacturing method of an electrostatic charge image developing toner, comprising:
a first aggregation step of aggregating polyester resin particles in a dispersion containing the polyester resin particles to form first aggregated particles;
a second aggregation step of mixing the dispersion containing the first aggregated particles with a dispersion containing amorphous polyester resin particles, and while agitating the mixed dispersions, adhering the amorphous polyester resin particles on a surface of the first aggregated particles to form second aggregated particles; and
a coalescence step of heating the dispersion containing the second aggregated particles for coalescing the second aggregated particles to form toner particles,
wherein the second aggregation step satisfies the following expression (1), expression (2), and expression (3),

$$35 \leq Tc \leq ( Tgs - 5 ) , \qquad expression ( 1 )$$

$$10 \leq Ts \leq Tc , \qquad expression ( 2 )$$

$$0.6 \leq ( P - P 0 ) \leq 3. , \qquad expression ( 3 )$$

where Tgs is a glass transition temperature (° C.) of an amorphous polyester resin contained in the amorphous polyester resin particles,
Tc is a temperature (° C.) of the dispersion containing the first aggregated particles at a start of the mixing,
Ts is a temperature (° C.) of the dispersion containing the amorphous polyester resin particles at the start of the mixing,
P is an agitation power (kW/m³) per unit volume, and
P0 is an idle agitation power (kW/m³) per unit volume.
   (((2)))

The manufacturing method of an electrostatic charge image developing toner according to (((1))),
wherein an acid value of the amorphous polyester resin contained in the amorphous polyester resin particles is 8 mgKOH/g or more and 16 mgKOH/g or less.
   (((3)))

The manufacturing method of an electrostatic charge image developing toner according to (((1))) or (((2))),
wherein the second aggregation step further satisfies the following expression (4) and expression (5),

$$10 \leq Wc \leq 20 , \qquad expression ( 4 )$$

$$5 \leq ( Ws - Wc ) \leq 20 , \qquad expression ( 5 )$$

where Wc is a concentration of solid contents (% by mass) of the dispersion containing the first aggregated particles at the start of the mixing, and
Ws is a concentration of solid contents (% by mass) of the dispersion containing the amorphous polyester resin particles at the start of the mixing.
   (((4)))

The manufacturing method of an electrostatic charge image developing toner according to any one of (((1))) to (((3))),
wherein, in the first aggregation step, the dispersion containing the polyester resin particles is a dispersion containing amorphous polyester resin particles and crystalline polyester resin particles, and
a total amount of the amorphous polyester resin particles and the crystalline polyester resin particles is 45% by mass or more of a total solid content of the dispersion containing the polyester resin particles.
   (((5)))

The manufacturing method of an electrostatic charge image developing toner according to any one of (((1))) to (((4))),
wherein, in the first aggregation step, the dispersion containing the polyester resin particles is a dispersion further containing colorant particles, and
a zeta potential of a colorant particle dispersion used for preparing the dispersion (that is measured after a concentration of solid contents of the colorant particle dispersion, a concentration of hydrogen ion in the colorant particle dispersion, and a temperature of the colorant particle dispersion are adjusted to 10% by mass, pH 6, and 25° C.) is −40 mV or more and −15 mV or less.
   (((6)))

The manufacturing method of an electrostatic charge image developing toner according to any one of (((1))) to (((5))),
wherein, in the first aggregation step, the dispersion containing the polyester resin particles is a dispersion further containing vinyl-based resin particles, and
a difference between a solubility parameter of a vinyl-based resin contained in the vinyl-based resin particles and a solubility parameter of the amorphous polyester resin contained in the amorphous polyester resin particles of the second aggregation step is 1.0 (cal/cm³)^{0.5} or less.
   (((7)))

The manufacturing method of an electrostatic charge image developing toner according to any one of (((1))) to (((6))),
wherein, in the second aggregation step, the dispersion containing the amorphous polyester resin particles further contains release agent particles.
   (((8)))

The manufacturing method of an electrostatic charge image developing toner according to any one of (((1))) to (((7))),
wherein the first aggregation step, the second aggregation step, and the coalescence step are performed in an agitated vessel provided with an agitation unit and a heating and cooling unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A manufacturing method of an electrostatic charge image developing toner, comprising:
a first aggregation step of aggregating polyester resin particles in a dispersion containing the polyester resin particles to form first aggregated particles;
a second aggregation step of mixing the dispersion containing the first aggregated particles with a dispersion containing amorphous polyester resin particles, and while agitating the mixed dispersions, adhering the amorphous polyester resin particles on a surface of the first aggregated particles to form second aggregated particles; and
a coalescence step of heating the dispersion containing the second aggregated particles for coalescing the second aggregated particles to form toner particles,
wherein the second aggregation step satisfies the following expression (1), expression (2), and expression (3),
$$35 \leq Tc \leq ( Tgs - 5 ) , \qquad expression ( 1 )$$
$$10 \leq Ts \leq Tc , \qquad expression ( 2 )$$
$$0.6 \leq ( P - P 0 ) \leq 3. , \qquad expression ( 3 )$$
where Tgs is a glass transition temperature (° C.) of an amorphous polyester resin contained in the amorphous polyester resin particles,
Tc is a temperature (° C.) of the dispersion containing the first aggregated particles at a start of the mixing,
Ts is a temperature (° C.) of the dispersion containing the amorphous polyester resin particles at the start of the mixing,
P is an agitation power (kW/m³) per unit volume, and
P0 is an idle agitation power (kW/m³) per unit volume.

2. The manufacturing method of an electrostatic charge image developing toner according to claim 1,
wherein an acid value of the amorphous polyester resin contained in the amorphous polyester resin particles is 8 mgKOH/g or more and 16 mgKOH/g or less.

3. The manufacturing method of an electrostatic charge image developing toner according to claim 1,
wherein the second aggregation step further satisfies the following expression (4) and expression (5),
$$10 \leq Wc \leq 20 , \qquad expression ( 4 )$$
$$5 \leq ( Ws - Wc ) \leq 20 , \qquad expression ( 5 )$$
where Wc is a concentration of solid contents (% by mass) of the dispersion containing the first aggregated particles at the start of the mixing, and
Ws is a concentration of solid contents (% by mass) of the dispersion containing the amorphous polyester resin particles at the start of the mixing.

4. The manufacturing method of an electrostatic charge image developing toner according to claim 1,
wherein, in the first aggregation step, the dispersion containing the polyester resin particles is a dispersion containing amorphous polyester resin particles and crystalline polyester resin particles, and
a total amount of the amorphous polyester resin particles and the crystalline polyester resin particles is 45% by mass or more of a total solid content of the dispersion containing the polyester resin particles.

5. The manufacturing method of an electrostatic charge image developing toner according to claim 1,
wherein, in the first aggregation step, the dispersion containing the polyester resin particles is a dispersion further containing colorant particles, and
a zeta potential of a colorant particle dispersion used for preparing the dispersion (that is measured after a concentration of solid contents of the colorant particle dispersion, a concentration of hydrogen ion in the colorant particle dispersion, and a temperature of the colorant particle dispersion are adjusted to 10% by mass, pH 6, and 25° C.) is −40 mV or more and −15 mV or less.

6. The manufacturing method of an electrostatic charge image developing toner according to claim 1,
wherein, in the first aggregation step, the dispersion containing the polyester resin particles is a dispersion further containing vinyl-based resin particles, and
a difference between a solubility parameter of a vinyl-based resin contained in the vinyl-based resin particles and a solubility parameter of the amorphous polyester resin contained in the amorphous polyester resin particles of the second aggregation step is 1.0 (cal/cm³)^{0.5} or less.

7. The manufacturing method of an electrostatic charge image developing toner according to claim 1,
wherein, in the second aggregation step, the dispersion containing the amorphous polyester resin particles further contains release agent particles.

8. The manufacturing method of an electrostatic charge image developing toner according to claim 1,
wherein the first aggregation step, the second aggregation step, and the coalescence step are performed in an agitated vessel provided with an agitation unit and a heating and cooling unit.
